(19) United States
(12) Patent Application Publication
(10) Pub. No.: US 2003/0007844 A1
(43) Pub. Date: Jan. 9, 2003

(54) Anti-loosening nut for threaded fasteners

(76) Inventor: Sydney Lee Terry, Grosse Point Farms, MI (US)

Correspondence Address: REISING ETHINGTON BARNES KISSELLE, LEARMAN AND MCCULLOCH PC, P O BOX 4390, TROY, MI, 48099-4390, US

(21) Appl. No.: 10/160,485

(22) Filed: May 31, 2002

Related U.S. Application Data
(60) Provisional application No. 60/294,896, filed on May 31, 2001.

(51) Int. Cl. F16B 39/284

(52) U.S. Cl. 411/186

(57) ABSTRACT

A threaded nut which resists loosening under vibration and shock forces which comprises a nut body which transmits load to the mating threads of the nut and bolt through two distinct load paths from two separate load seating faces on the nut for transmitting forces to the workpiece with one seating face being disposed radially outwardly of the other with the load path transmitting load to different regions of the threads.

### FIELD OF THE INVENTION

This invention relates to threaded fasteners; more particularly, it relates to a threaded fastener with an improved nut which is resistant to loosening.

### BACKGROUND OF THE INVENTION

There has been a longstanding need for threaded fasteners which will withstand severe conditions of usage such as vibration, shock and impact without becoming undesirably loose in service and yet may be purposely loosened and retightened. In order to satisfactorily fulfill such need, the fastener must also be of simple construction, easy to manufacture in high volume and of low cost.

As fully disclosed hereinafter, the threaded nut of this invention comprises a nut body configured to transmit the clamping load to the mating threads of the fastener through two different load paths. This feature distinguishes this invention from the known prior art.

However, the prior art U.S. Pat. No. 5,927,921, granted Jul. 27, 1999 is acknowledged as disclosing a nut having a load distributing profile that reduces the limiting stress on the threads. This patent discloses a flange nut in which the nut face defines an annular groove located between inner and outer annular portions with the inner portion being recessed into the nut face relative to the outer portion whereby the inner portion does not seat against any clamped member when the nut is tightened.

### SUMMARY OF THE INVENTION

In accordance with this invention, an anti-loosening nut is provided which is usable with a conventional bolt and is highly resistant to unwanted loosening and which is of simple construction, easy to manufacture in high volume and low cost. This is accomplished by a nut structure which includes a nut body configured to transmit load to the mating threads of the nut and a conventional bolt (or other threaded male member) through two distinct load paths. The inventive nut, herein termed a “split-load nut”, is effective to provide a more uniform distribution of load to the mating threads than that obtained in a conventional nut and bolt. The resulting load distribution on the threads produces a self-locking effect within the threads themselves with a high degree of resistance to unwanted loosening, especially under conditions of transverse vibration forces and yet without interference to loosening by a standard wrench. By transmitting the clamping load through different paths to different threads, the threads themselves serve to inhibit loosening. Further, the resulting thread load distribution has the advantage of reducing the maximum stress level in the threads which contributes to improved fatigue life of the nut and bolt

Further, in accordance with this invention, an anti-loosening nut is provided which comprises a threaded nut member adapted to receive a threaded shank at its inner end, and includes first and second load seating faces for transmitting compressive forces from said nut member to a workpiece with the first load seating face being disposed radially outwardly of the second load seating face, whereby tightening of the nut on the threaded shank against the workpiece causes the load to be applied to the threads of the nut and the shank with a first part of the load being applied by the first load seating face through a first load path to a first region of said threads and with a second part of said load being applied by said second load seating face to a second region of said threads.

Further, in accordance with this invention, a first and second load seating faces are unitary with said nut member and said nut member defines an annular flange at the lower end and the first seating face is disposed on the flange, and the second seating face is disposed radially inwardly of the flange and separated therefrom by an annular groove.

Further, in accordance with this invention, an anti-loosening nut is provided wherein the first and second seating faces are axially spaced from each other and a cupped shaped washer is included having a peripheral rim with a load bearing surface in axial alignment with the first seating surface and having an inwardly extending radial flange with the second load bearing surface in axial alignment with the second seating face.

Further, in accordance with this invention, an anti-loosening nut is provided which includes a flat washer and a belleville spring coacting with the nut member to provide two distinct load paths to the threads of the nut.

A complete understanding of the invention will be obtained from the detailed description that follows taken with the accompanying drawings.

### DESCRIPTION OF THE DRAWINGS

FIG. 1 is a perspective view of a threaded nut according to this invention;

FIG. 2 is a cross-sectional view of the nut shown in FIG. 1;

FIG. 3 is a cross-sectional view of a fastener assembly including the threaded nut of FIG. 1 in its unstressed state, i.e. before the nut is tightened;

FIG. 4 is a cross-sectional view of the nut assembly of FIG. 3 after the nut is tightened;

FIG. 5 is an exploded view in perspective of a second embodiment of the nut of this invention;

FIG. 6 is an exploded view in cross-section of the nut shown in FIG. 5;

FIG. 7 is a cross-sectional view of a fastener assembly including the threaded nut of FIG. 5 in its unstressed state, i.e. before the nut is tightened; and

FIG. 8 is a cross-sectional view of the nut assembly of FIG. 7 after the nut is tightened.

FIG. 9 is a cross-sectional view of a third embodiment of the nut of this invention;

FIG. 10 is an exploded view in perspective which depicts a modification of the second embodiment of the nut;

FIG. 11 is an elevation view, partly in section, of the nut assembly of FIG. 10 in a tightened condition,

FIG. 12 is a developed view showing the contour of the cam structures of a prior art anti-loosening mechanism; and

FIG. 13 shows a cross-sectional view of a prior art thread form which can be used with this invention.

### BEST MODE FOR CARRYING OUT THE INVENTION

Referring now to the drawings, three different embodiments of the invention are shown in a threaded nut for use with a conventional bolt (or other threaded male member). It will be appreciated, as the description proceeds that the invention may be used in a wide variety of fastener applications and may be implemented in many different embodiments.

### First Embodiment of the Invention

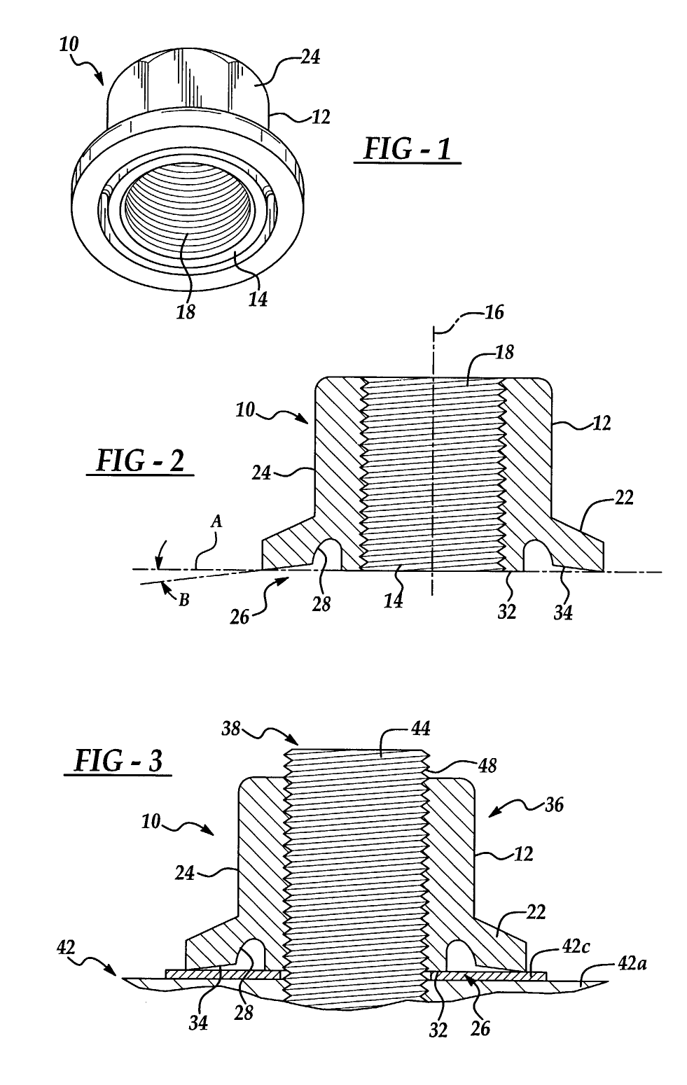

The split load nut of this invention is shown in a first embodiment in FIGS. 1, 2, 3 and 4.

As shown in FIGS. 1 and 2, the split-load nut 10 has a nut body 12 which defines a cylindrical bore 14 having a longitudinal axis 16. The cylindrical bore is provided with female threads 18 which are suitably of any conventional thread form. The nut body 12 has an exterior surface which defines a nut flange 22 on the inner end of the nut body 12. The nut body 12 is provided with a tool receiving shape at the outer end, such as a hexagonal head member 24.

The nut body 12 is provided with an inner end surface of special configuration. The purpose of the special surface configuration is to provide a structure of the nut body so that the load transmitted by the nut to the workpiece is divided into two distinct load paths in accordance with this invention. In order to adapt the design of the nut to different applications, the nut is configured to split the load between the two paths in a predetermined proportion. The end surface 26 of the nut body 12 is formed with an annular groove 28 which is coaxial with the cylindrical bore of 14 of the nut. Also, the end surface 26 is formed with a nut face or load seating face 32 of annular configuration coaxial with the cylindrical bore 14. The load seating face 32 is flat and defines a plane A which is perpendicular to the longitudinal axis 16. The end surface 26 is formed with another nut face or load seating face 34 which is beveled (i.e., is a conical surface) and has an annular configuration coaxial with the bore 14. The load seating face 34 as shown in FIG. 2 has a bevel angle B relative to the plane A and, at its outside diameter, it lies in the plane A.

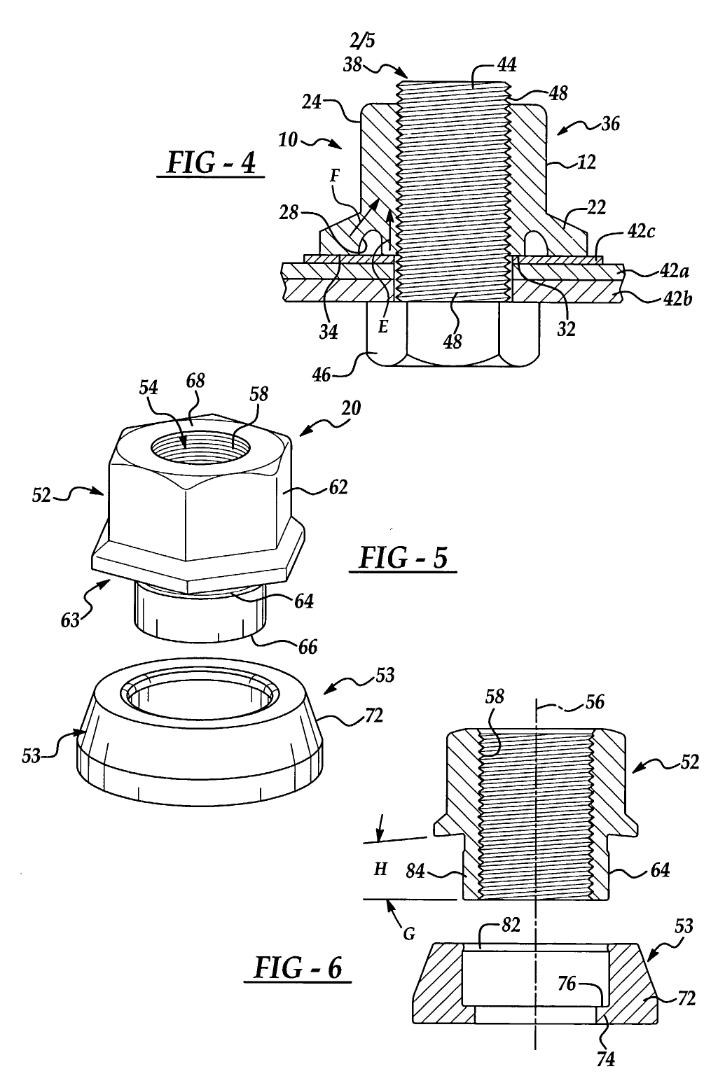

FIGS. 3 and 4 show a fastener assembly 36 which, in general, comprises the nut 10 and a bolt 38 which connect the parts of a workpiece assembly 42, which for example, includes a pair of plates 42a and 42b and a washer 42c. The bolt 38 is of conventional structure and has a threaded shank 44 and a hexagonal head 46. The shank is provided with male threads 48 which mate with threads 18 of the nut 10.

The use of the nut 10 in the fastener assembly 36 and its anti-loosening properties will now be described with reference to FIGS. 3 and 4. The fastener assembly 40, as shown in FIG. 3, is loosely assembled and in readiness for the nut 10 to be tightened on the bolt 38 against the workpiece assembly 42. In this loose assembly, the nut 10 is in its unstressed or relaxed state. The nut is supported by threaded engagement with the bolt 38 without forceful engagement against the workpiece assembly 42. In this condition, there is no significant load on the threads 18 of the nut or the threads 48 of the bolt. When the nut 10 is rotated in the tightening direction and thereby advanced toward the workpiece assembly 42, the outer peripheral edge of the load seating face 34 and the load seating face 32 will engage the workpiece assembly at about the same time. As the tightening of the nut 10 progresses with greater torque, the flange 22 of the nut is deflected in the axial direction and the load seating face 34 is angularly displaced toward parallelism with the load seating face 32. As soon as both seating surfaces 32 and 34 are engaged, the load on the nut is shared to some degree. Preferably, the specified final tightening torque causes the entire seating face 34 to engage the workpiece. The tension load on the bolt 42 imposes a load on the nut 10 which is supported on the workpiece assembly. Accordingly, the nut 10 applies a load force to the threads of the bolt 42 through two distinct load paths as indicated by arrows E and F in FIG. 4. It is significant to note that the load path E transmits part of the load to the threads at the proximate or inner end of the nut body 12 (adjacent the load seating face 32) and the remainder of the load is transmitted through the load path F to the threads further up towards the distal or outer end of the nut body. Thus, the load carried by the nut 10 is distributed more uniformly over the threads as a result of the split load paths E and F.

### Second Embodiment of the Invention

The split-load nut of this invention is shown in a second embodiment in FIGS. 5, 6, 7 and 8.

As shown in FIGS. 5 and 6, the split-load nut 20 comprises a first nut member 52 and a second nut member 53. The first nut member 52 has a body which defines a cylindrical bore 54 having a longitudinal axis 56. The cylindrical bore is provided with female threads 58 which are suitably of any conventional thread form. The nut member 52 has an exterior surface which defines a tool receiving shape at the outer end, such as a hexagonal head member 63. The body of the first nut member 52 also comprises a unitary nut extension member 64 at the inner end. The female threads 58 are continuous through the nut extension member 64 and the head member 62. The nut extension member 64 has a cylindrical outer surface which terminates at its outer end in an annular shoulder 63 on the head member 62. A nut face or load seating face 66 of annular configuration is provided on the lower surface of the nut extension member 64. This load seating face 66 has a flat surface which lies in a plane G perpendicular to the longitudinal axis 56. Another nut face or load seating face 68 with a conically concave annular surface is formed on the shoulder. Both of the load seating faces 66 and 68 are coaxial with the cylindrical bore 54. As shown in FIG. 6, the load seating face 68 has a bevel angle H relative to the plane G.

An important reason that load seating face 68 is beveled instead of being parallel with load seating face 66 is to facilitate manufacture of the nut such that the load carried by the nut is divided between the seating faces 68 and 66 in approximately equal shares, say within the range of no less than forty percent on one and no greater than sixty percent on the other. If the nut member 52 is manufactured with load seating surfaces 66 and 68 parallel with each other for engagement with the nut member 53 the tolerances in the axial dimensions would have to be extremely tight in order to assure that both seating faces 66 and 68 touch down simultaneously during tightening of the nut. Instead of the tight manufacturing tolerances, it is preferred to construct the load seating face 68 as a concave conical seat with a bevel angle of about five degrees so that both seating faces will be engaged at relatively low bolt load or tightening torque. Thus, at full torque both load paths K and L (which are described below) will carry loads which are proportional to their relative stiffness.

The second nut member 53, as shown in FIGS. 5 and 6, is cup-shaped washer with a cylindrical ring-shaped body 72 that surrounds the nut extension member 64 with a loose-fit so that the first and second nut members can be freely rotated relative to each other. The nut member 53 has a uniform wall thickness except for an inwardly directed annular flange 74 and an annular rib 82. The flange 74 has a radial width sufficient to provide a load bearing surface 76 for the load seating face 66 of the nut member 52. The nut member 52 terminates at its outer end in a flat bearing surface 78. The nut member 53 has an axial length such that the load seating face 66 is in loose or unstressed engagement with the load bearing surface 76 when the outer perimeter of the load seating face 68 is in loose or unstressed engagement with the load bearing surface 78. Preferably, the second nut member 53 is held in a captive relationship with the first nut member 52. For this purpose, the annular rib 82 is provided on the inner diameter of the nut member 53 and a complementary annular rib 84 is provided on the external diameter of the nut extension member 64. The ribs 82 and 84 are formed with a cross-sectional shape and location so that the nut member 53 may be force-fit on the nut member 52 with a detent action and which will allow axial play between the members while retaining a captive relationship.

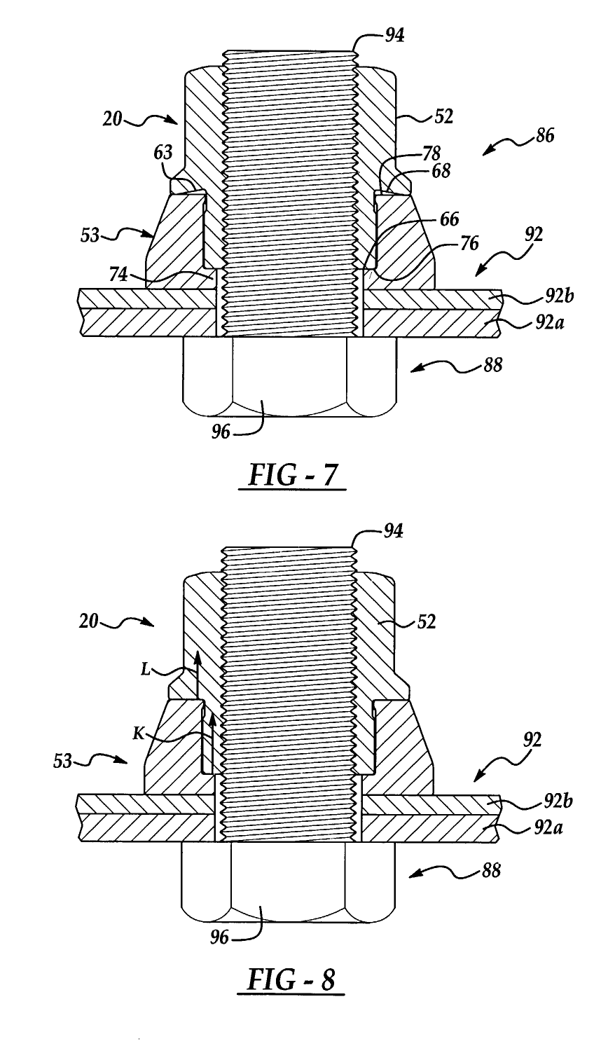

FIGS. 7 and 8 show a fastener assembly 86 which, in general, comprises the nut 20 and a bolt 88 which are used, for example, to connect parts of a workpiece assembly 92 including workpieces 92a and 92b. The bolt 88 is of conventional structure with a threaded shank 94 and a hexagonal head 96. The shank is provided with male threads 98 which mate with the threads 58 of the nut 20.

The use of the nut 20 in the fastener assembly 86 and its anti-loosening properties will now be described with reference to FIGS. 7 and 8. The fastener assembly 86 as shown in FIG. 7 is loosely assembled and is in readiness for the nut 50 to be tightened on the bolt 88 against the workpiece assembly 92. In this loose assembly, the nut 20 is in its unstressed or relaxed state. The nut is supported by threaded engagement with the bolt 88 without forceful engagement against the workpiece assembly 92. In this condition, there is no significant load on the threads of the nut or the bolt. When the nut 20 is rotated in the tightening direction and thereby advanced toward the workpiece assembly 92, the outer peripheral edge of the load seating face 68 and the load seating 66 will engage the workpiece assembly at about the same time. As the tightening of the nut 20 progresses, the shoulder 63 of the nut member 52 is deflected in the axial direction and the load seating face 68 is angularly displaced toward parallelism with the load seating face 66 of the nut extension member 64. This tightening load is transferred through the bolt threads 98 and nut threads 58 to the first nut member 52 which is supported at its outer periphery by the load bearing surface 78. At an early stage of tightening, the load on the nut is shared to some degree by the seating faces 66 and 68. Preferably, the specified final tightening torque causes the entire seating surface 68 to engage the bearing surface 78. The tensile load on the bolt 88 imposes a load on the nut 20 which is supported on the workpiece assembly 92. Accordingly, the nut 10 applies a load force to the threads of the bolt 88 through two distinct load paths as indicated by arrows K and L in FIG. 8. It is significant to note that the load path K transmits part of the load to the threads at the proximate or inner end of the nut body 52 (adjacent the load seating face 66) and the remainder of the load is transmitted through the load path L to the threads at the distal or outer end of the nut body 52. Thus, the load carried by the nut 20 is distributed more uniformly over the threads as a result of the split load paths K and L.

With the split-load nuts described above, the outside portion of the nut or the underlying washer can have serrations or a roughened surface resulting in a much higher coefficient of friction, particularly in the loosening direction, compared with the inside section, which takes most of the load, particularly when tightening. This allows the designer to increase the resistance to loosening on the outside of the nut without unduly increasing or influencing the tension to torque ratio which is an important advantage.

### Third Embodiment of the Invention

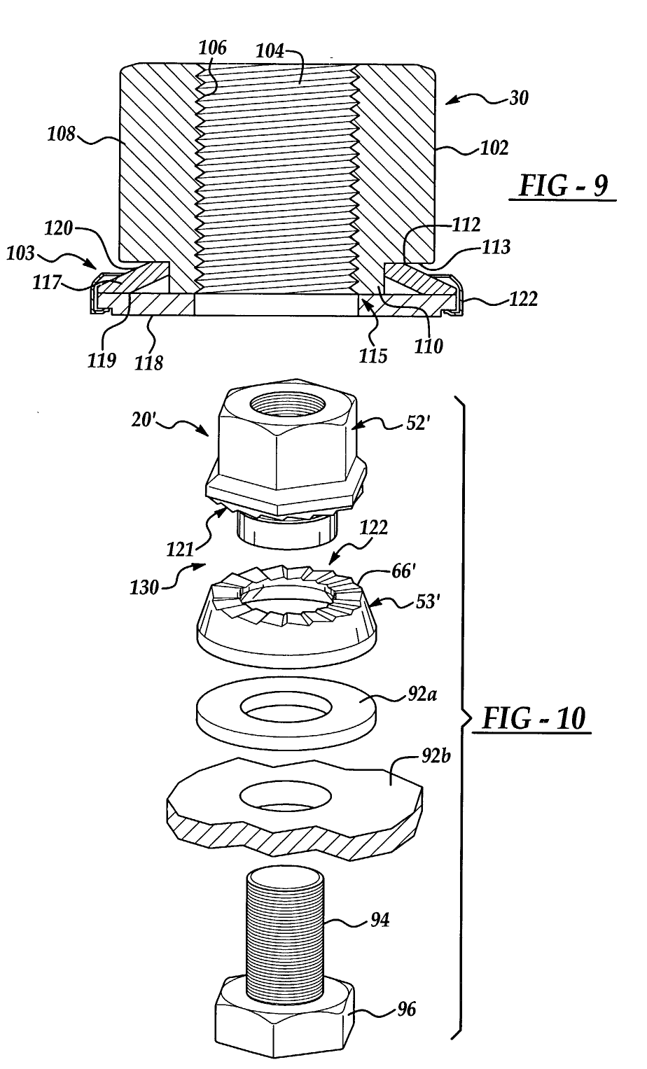

The split-load nut of this invention is shown in a third embodiment in FIG. 9.

As shown in FIG. 9, the split-load nut 30 comprises a first nut member 102, a first and a second nut member 103. The first nut member 102 comprises a cylindrical bore 104 which is provided with female threads 106 which may be of any desired conventional thread form. The body of the nut member 102 also comprises a head member 108 and a unitary nut extension member 110 of smaller diameter at the inner end. A load seating face 115 is provided on the inner surface of the nut extension member 110. The threads 106 are continuous through the extension member and the head member. Thus, the first nut member of the nut 30 is generally similar in configuration to the first nut member 52 of the second embodiment of the this invention. However, it differs in that the nut extension 110 is relatively shorter in axial length and it has an exterior cylindrical surface which is of uniform diameter. The annular shoulder 112 has an inner surface 113 which is suitably perpendicular to the longitudinal axis of the nut member 102 and hence it is parallel with the nut face or load seating face 115.

The second nut member as shown in FIG. 9, comprises a flat washer 118 and a belleville spring 120 which is suitably secured to the flange extension 110, such as by a pressed fit thereon. The nut member 103 may also comprise an annular spring clip 122 which holds the flat washer 118 captive to the belleville spring 120. The belleville spring has a load seating face 117 which abuts a load bearing surface 119 on the upper face of the washer 118. The belleville washer 120 is secured to the nut body 102 and is rotatable therewith relative to the flat washer 118 when the nut is tightened or loosened. The conical angle of the belleville washer may be selected as desired to obtain the stiffness and uniformity.

It will be understood that the principle of operation the nut 30 is similar to that described above with reference to the nut 20 in that it has a first load path through the belleville washer 120 to the flat washer 118 and has a second load path from the nut member 102 through the nut extension 110 to the flat washer 118.

Accordingly, the use of the nut 30 in a fastener assembly and its anti-loosening properties are similar to that described above with reference to the second embodiment of the invention.

### Operation of Anti-Loosening Nut

The anti-loosening nut of this invention is provided with a structure which is designed to produce a more uniform distribution of the tightening load on the threads of the nut. As described above, this is accomplished in the first embodiment by a one-piece nut having a nut body of special shape which provides two distinct load paths E and F for transmitting the compression load on the nut to the nut threads. In the second embodiment of the invention, a more uniform distribution of load is provided in a two-piece nut in which the second nut member is a washer of special shape for coacting with the threaded nut member to provide two distinct load paths K and L for transmitting the compression load through the body of the threaded nut member to the threads of the nut. The third embodiment similarly provides two distinct load paths.

It has been found that the split-load nuts of this invention when used with conventional bolts with conventional thread forms, are highly resistant to unwanted loosening under conditions of extreme vibration. It is believed that the split-load nut structure results in a pattern of thread load distribution which responds to vibration forces in a manner which tends to inhibit loosening movement of the nut. The explanation of the behavior given below is the most plausible explanation presently known by the inventor.

### Theory of Operation

The split-load nut of this invention, as described above, exhibits high resistance to loosening when subjected to vibrations which impose transient forces acting in a direction transverse to the fastener axis.

It is well known that vibration, shock and impact forces acting on a threaded fastener assembly are the most common cause of unwanted loosening of the fastener. Before examining the effects of such extraneous forces, it will be helpful to consider the tension forces and torque in a bolt and nut during and after the tightening operation.

### Unwanted Loosening in the Conventional Nut

Assume for explanatory purposes that the head of the bolt is stationary during the tightening motion of the nut. As the nut moves down the bolt threads during its tightening motion, it begins to exert force on the workpiece due to the increasing tension in the bolt; this causes friction forces to increase between the threads and between the nut seat and the workpiece in proportion to the increase in bolt tension. There are three separate torques which resist tightening of the nut, namely, the friction torque between the threads, the friction torque between the nut seat and the workpiece, and the working torque (called the pitch torque) needed to run the nut down the threads to increase the bolt tension and hence the clamping force on the workpiece. These torques resist tightening of the fastener and must be overcome by the input or tightening torque.

When the nut is tightened to the desired maximum torque and the input torque is removed, at least one of the three torques described above must reverse, i.e. it must change from resisting further tightening to resisting loosening. Testing reveals that, in the case of “hard joints”, i.e. workpieces and washers of rigid materials, the seat torque reverses and, instead of opposing tightening, it opposes loosening of the nut. This reversal of seat friction torque occurs concurrently with the release of the input torque and is typically accompanied by some loss of tension and by a considerable loss of bolt torque. However, a residual seat torque remains and opposes loosening of the nut after the tightening torque is removed. Thus after tightening, only the friction torque in the threads and the seat torque on the nut keep the nut in a tightened condition.

In the conventional threaded nut, the load carried by the nut is not distributed uniformly among the threads. The thread which is axially closest to the flange or surface carrying the load, typically the thread next to the seat of the nut, carries about 50% to 60% of the total load. The second thread usually carries 25% to 30% and each succeeding thread carries only about half of the load carried by the preceding thread. The fifth and remaining threads of the nut carry a negligible amount of the total nut load. This unequal loading on the threads is due to the deflection or deformations in the threads themselves and the material supporting the threads. Bolt threads are in tension and are pulled apart as the bolt is stretched while the nut threads are in compression and are pressed closer together by the bolt threads. Thus mating threads of conventional nuts and bolts are deflected in opposite directions when they are tightened. As a result, the load is concentrated in the threads closest to the point where the load is being transmitted from the nut structure to the mated threads of the nut and bolt.

The main cause of loosening of the threaded nut is vibration, shock and impact which impose transverse forces on the nut or bolt, i.e. those forces having a component normal to the axis of the bolt. If vibratory transverse forces are high enough they cause an increment of motion between the threads which allows a small amount of slippage to occur between the threads. Any motion between the mating threads will result in a small motion component in the loosening direction because of the loosening torque trapped in the system during tightening. In the conventional nut and bolt lightly loaded threads may slip first and the loosening motion moves toward the seat until the loosening torque at the seat builds up enough to move the seat and release a small increment of the original clamping force. This effect is progressive between the mating threads toward the seat of the nut until slippage starts to occur between the highest loaded threads at the seat which then moves the seat incrementally and allows loosening of the nut to take place. The bolt will always lose tension and torque if there is relative motion between the mating threads at the seat.

The friction grip between the threads tends to keep them from loosening under load. However, if the loaded threads “slip” relative to each other due to transverse vibration in service, the slippage motion will have a small component in the loosening direction. Thus any actual motion between the threads will be cumulative in the loosening direction. The loosening process is aided by the fact that static friction is much higher than dynamic friction. Thus, once sliding begins between threads, the resistance to movement is greatly reduced and the motion continues further than it otherwise would.

In summary, this theory of thread loosening is that it is due to repetitive migrating build-ups of loosening torque towards the highest-loaded threads next to the nut seat which are periodically relieved by minute loosening slippage at the seat. Since some energy is lost with each increment of slippage at the seat, continued vibration sufficient to cause actual slippage between the threads eventually loosens the nut or bolt. Test experience of split-load nuts against conventional nuts confirms this theory when they are both subjected to high transverse vibration loading using Junker-type machines.

### The Split-Load Nut of this Invention

The split-load nut is designed to prevent the migration of the loads carried by threads slipping towards the seat. The one-piece nut splits the load on the nut seat between an inner and an outer portion, with the outer portion designed to contact the seat at the same time as the flat center section. Thus the additional loads on the seat caused by tipping action due to transverse vibration loads is transferred through the outside skin of the nut to threads above the seat (which take much lower loads) and therefore may not add to loosening slippage.

The split-load nut permits increased loading of threads which, in the conventional nut are in contact but carry virtually none of the bolt load. If the seat load on a flange nut is separated into an inside and an outside portion of the load, the inside portion carries the thread-load directly in compression, whereas the outside portion tends to load threads further up in the nut. This tendency can be increased by having the outside of the flange contact the workpiece first, thus assuring a full-pressure center of contact as far to the outside as the geometry permits. When side loads are encountered, the fastener tends to be tipped and the load is shifted towards the outside of the nut seat. This increases the load on the relatively low loaded threads remote from the seat, which threads can absorb higher loads without carrying them through other lower loaded threads to the seat. This is the way the one-piece nut of the first embodiment works to absorb transverse vibrations into the threads without loosening at the seat. In addition, in the two-piece nut of the second embodiment some of the load is carried up to a point above the significant load-carrying threads and there is much more tipping resistance to motion between the nut and the bolt threads. This is also true of the third embodiment.

Splitting the load and applying it at two levels through a two-level washer is effective to reduce thread load migration to the seat because thread-loads taken by the upper seat or flange result in tension loads in the threads on the other side of the flange and thus relieves the compressive loads on these threads to some extent. It is believed that compressive thread loads will not migrate through these lower loaded threads between the two load-carrying areas.

The split-load nut is designed to direct the tipping forces due to transverse loads on the fastener up further from the flange into lower loaded threads. It is believed that this prevents higher thread loading from migrating towards the seat (where the thread loads are highest) and consequently, inhibits sliding at the seat, which must occur for loosening to take place.

The outer flange spreads out or cushions any tipping loads on the flange due to transverse loading in service. This cushioning effect helps to maintain contact at both nut seats when transverse vibration loads are applied, and therefore, by maintaining seat loads and seat contact, keeps the seats from relative motion when severe side loads are encountered. Having the outside of the flange make contact first also helps to direct the load through the outside of the nut body along load path F (which is described below) toward the upper threads and around the concentrated highly loaded lower threads adjacent seat.

The split-load nut, especially the two-piece split-load nut, uses the outside portion of the compression load passing through the nut to load the previously lightly-loaded threads furthest from the seat, which improves the distribution of the load among the threads. This, in itself, improves the “grip” of the threads and helps prevent thread loosening with increased thread friction. It also reduces the maximum stress in the threads. But perhaps the biggest advantage of this redistribution of the thread loads is the break in continuity of thread loading that occurs as a result of introducing a relatively high load into a section of mating threads that otherwise would be low-loaded; it is believed that this produces a low-loaded section of mating threads which is disposed between two high-loaded sections of mating threads. It is believed that the low-loaded section represents a reservoir of potential energy absorption that can prevent the passage of thread load down to the seat, which is believed to be the ultimate cause of thread slippage at the seat. In other words, the nut can't loosen at the seat unless the thread adjoining it slips, and that can't happen unless the threads above that slip, and so on up the line to the lowest load threads.

The advantages of the split load nut includes the following:

The proportions of the load carried by the inside and outside of the nut can be controlled by design; by making them equal, the maximum thread load can be potentially reduced by 50%.

The vertical distance between the two load points provides a moment arm between the two load application points which resists any tipping separation between the threads of the bolt and nut. Standard nuts and bolts have virtually no similar built-in moment to resist tipping because of the very concentrated thread loads.

Splitting the load vertically provides several lower loaded threads between the higher loaded threads at the direct load points which can act as a kind of storage area between the high loaded threads and break up the continuous squirming action that loosens threads.

### Modification of the Second and Third Embodiments

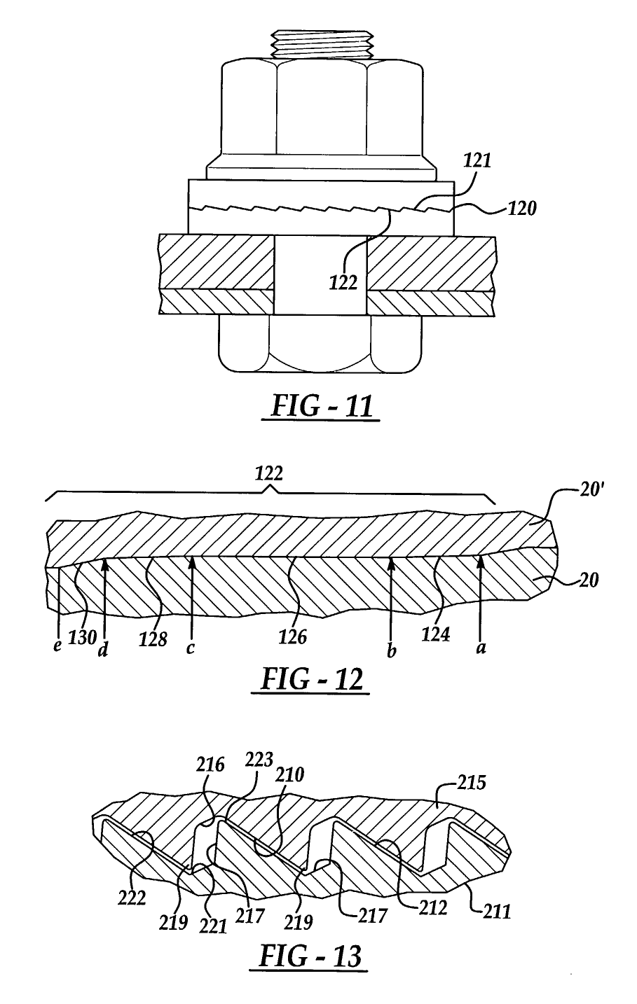

It may be desired in some applications of this invention to provide the split-load nut with resistance to loosening in addition to that provided by the split load design. FIGS. 10,11 and 12 show a modification of the second embodiment of this invention to provide such additional resistance to loosening. This modification resides in the addition of an anti-loosening mechanism 130 comprising a pair of face-to-face cam structures 121 and 122 incorporated in the first nut member 52′ and the second nut member of 53′ (in the fastener assembly shown in FIGS. 10 and 11, the parts which are the same are designated by the same reference characters as in FIGS. 5 and 6 whereas those parts which are different or modified are designated by the same reference characters including a prime symbol). The first cam structure 121 is formed on the load seating face 68′ of the first nut member 52′. The second cam structure 122 is formed on the load seating face 66′. The second cam structure 122 is a mirror image of the first cam structure 121 when the two cam structures confront each other as shown. The cam structure 121 comprises 18 cams which are of identical configuration. Each cam occupies an angular sector of 20°. FIG. 11 shows a fastener assembly in its tightened condition and the cam structures are “nested” with each other, i.e. the cam peaks on one are seated in the cam valleys on the other.

The configuration of the structure of one cam sector 122 is represented in the developed view of FIG. 12 (in this view the axial dimensions of the cam configuration are amplified to a greater extent than the circumferential dimensions in order to indicate the general configuration of the cam surface.) As shown in FIG. 12, the contour of a single cam sector 122 on the first cam structure is represented by straight line segments 124, 126, 128 and 130. Segment 124 extends between points a and b, segment 126 extends between points b and c, segment 128 extends between c and d, and segment 130 extends between points d and e. The contour of a single cam on the second cam structure 121 is represented by the same line segments as those representing the single cam on the first cam structure 122. The details of construction will be described with reference to the single cam 122, as shown in FIG. 12. Segment 124 (viewed at the outer periphery of the structure 121) is a flat valley and lies in a plane which is perpendicular to the axis of the washer and extends between points a and b. Segment 126 lies in a plane which is inclined relative to the axis of the washer and extends between points b and c. Segment 128 is a flat plateau and lies in a plane which is perpendicular to the axis of the washer and extends between points c and d. Segment 130 lies in a plane which is inclined relative to the axis of the washer extends between points d and e. The lead of cam segment 130 is greater than that of cam segment 126 and is in the opposite direction. The cam segment 126 has an angle which is less the static friction locking angle for the material of the cam surface, e.g. for steel the locking angle is about seven degrees. The cam segment 130 have an angle which is greater than the static friction locking angle. The cam segment 130 is sometimes referred to herein as the “cam wall” of an individual cam 22.

Both cam structures 121 and 122 are suitably constructed of steel and may be hardened and have a low friction coating on the surfaces. They may be formed on a conical surface as in the second embodiment or on a flat surface.

Both cam structures 121 and 122 are suitably constructed of steel and may be hardened and have a low friction coating on the surfaces. They may be formed on a conical surface as in the second embodiment or on a flat surface.

During tightening of the nut 20′ there is relative rotation of the cam structures with the cams of structure 121 passing over the cams of structure which produces small increases and decreases in the torque. Hence the individual cams 22 are sometimes referred to herein as “bump cams”.

When the desired value of tightening torque is reached the cam structures will be in some arbitrary relative position. The nut 20′ may be removed or loosened by simply unscrewing it in the same manner as an ordinary nut. The off-torque is generally greater than the on-torque because of the bump cam action.

When the joint is tightened member 53′ remains stationary. This causes the smooth seat of the member 53′ to dig into the workpiece microscopically, thus establishing a higher friction torque bond.

When the nut 20′ is tightened, passing over the cams causes the tightening torque and the bolt tension to rise with each high point and fall as the cams come together by an amount determined by the cam contours; a torque and bolt tension loss of ten percent to fifteen percent is a good target for determining the proper cam contours experimentally. The cam rise when tightening should be very gradual. On the other side, the cam fall should be at a higher angle—something over the friction locking angle of seven degrees—to force the member 53′ to move when the nut or bolt is loosened with a wrench. This faster fall angle is not necessary to make the joint secure against vibration, but it causes the breakaway torque to be much higher than it would otherwise be—generally higher than the tightening torque—thus demonstrating the higher friction torque bond earlier established by the cam action of the anti-loosening washers during the tightening.

The cam structures 121 and 122 (referred to above as “bump cams”) are believed to function to inhibit loosening of the fastener assembly in the following manner. When the workpiece is subjected to vibratory motion such motion is imparted, in some degree, to the member 53′ by reason of the frictional engagement of the washer 20 with the workpiece. The vibratory motion of the workpiece would be imparted to some degree through the to the nut member 52′, except for the isolation provided by the anti-loosening mechanism 130.

Thus, with the cams of the anti-loosening mechanism 16 in any random angular position, the mating cam surfaces of smooth and hard, low friction material provide a zone or “floating seat” which permits and even encourages motion between the confronting cam surfaces when there is vibrating motion of the workpiece. When a torque impulse is generated by vibratory motion of the workpiece the mating cam structures 121 and 122 can move with respect to each other but the steeper angle at the ends of the mating cams is sufficient to prevent any cumulative rotation between them. The cam structures can rotate back and forth in opposite directions but will not move over the cam wall as a result of vibratory torque likely to be experienced in the working environment of the threaded fastener.

### Modification of First, Second and Third Embodiments

If desired, additional resistance to loosening of the nut of this invention may be provided by thread-locking means such as a thread form known in the trade under the trademark “SPIRALOK”. An example of this thread form is shown in FIG. 13 and is described in U.S. Pat. No. 4,171,012, granted Oct. 16, 1979 to Horace D. Holmes. The entire disclosure of U.S. Pat. No. 4,171,012 is hereby incorporated by reference herein.

It will be appreciated by those skilled in the art that the thread form of FIG. 13 may be used in the threaded fasteners of the first, second and third embodiments described above. In view of the complete disclosure of the SPIRALOK® in said U.S. Pat. No. 4,171,012, only a brief description will be given herein, as follows:

The locking thread form is shown in FIG. 3 and is incorporated in buttress-type thread. As is conventional with threads of the buttress type, the nut thread 210 and the bolt thread 212 have one flank thereof at a substantial angle while the opposing flanks thereof have very small angle relative to the axis of the bolt or nut. As illustrated in FIG. 13, the thread of both the bolt 211 and nut 215 have the root flattened in a manner to provide a flat surface or ramp which slopes relative to the thread axis; the flat 216 at the root of the nut 215 is disposed at an angle of approximately 22½° relative to the thread axis, while the flat 217 at the root of the bolt thread 212 is disposed at an angle of approximate 30° from the axis of the thread.

It is to be noted that the aforesaid angles will vary with the degree of hardness of the material from which the bolt 211 and nut 215 are fabricated, and that when these elements are fabricated so as to be of similar or identical hardness, the angles of the flats or ramps 216 and 217 are preferably equal or approximately equal.

When the nut 215 is in the position illustrated in FIG. 13 with the crown 219 of its thread 210 disposed adjacent to the corner 221 of the bolt 211 between the flat surface 217 and the sloping face 222, the nut 215 is free running on the thread 212 and is freely rotatable toward the left until the nut 215 strikes the adjacent element 214, whereupon the continued rotation of the nut will cause the crowns 219 and flat 216 to move to the right engaging the flat sloping surface 217 and crown 223, respectively, and causing the softer metal of the crown 219 to deform. When the nut is tightened to provide a substantial degree of contact between the threads, the nut 15 is locked in position along the bolt shank. When an increased torque is applied to the nut 15, an even greater degree of contact will occur between the ramps 216,217 and the crowns 219,223 until the faces of the nut thread engages the faces of the bolt thread. When a specific torque is applied, relative lateral movement between the nut 215 and bolt 211 is positively prevented so as to assure against loosening thereof, which locked condition will exist until such time as a positive force is applied to unscrew the nut.

### Conclusion

Although this invention has been described with reference to particular embodiments, it is not to be construed in a limiting sense. Many variations and modifications will now occur to those skilled in the art. For a definition of the invention, reference is made to the appended claims.

1. An anti-loosening threaded nut for use in a threaded fastener assembly which includes said nut in threaded engagement with a threaded shank which has a head thereon whereby a compressive force can be applied to a workpiece disposed between said nut and said head, said nut comprising:
a nut member defining a cylindrical threaded opening having a longitudinal axis and having an inner end, said inner end being adapted for receiving said threaded shank,
first and second load seating faces on said nut for transmitting compressive forces from said nut to said workpiece with said first seating face being disposed radially outwardly of said second seating face,
whereby tightening of said nut on said threaded shank against said workpiece causes a load to be applied to the threads of said nut and said shank with a first part of said load being applied by said first load seating face through a first load path to a first region of said threads and with a second part of said load being applied by said second load seating face to a second region of said threads.

2. An anti-loosening nut as defined in claim 1 wherein:
said first and second load seating faces are unitary with said nut member.

3. An anti-loosening threaded nut as defined in claim 1 wherein:
said nut member defines an annular flange at said lower end and said first seating face is disposed on said flange.

4. An anti-loosening threaded nut as defined in claim 2 wherein:
said second seating face is a flat annular surface disposed substantially perpendicularly to said longitudinal axis and said first seating face is a beveled flat annular surface inclined between the outer periphery and the inner periphery of said annular surface.

5. An anti-loosening threaded nut as defined in claim 4 wherein:
said nut body is steel and the bevel angle of said first seating face relative to said second seating face can be in the range of about 2 to 12 degrees for design of the load division between the load paths.

6. An anti-loosening threaded nut as defined by claim 1 or 2 wherein:
said annular groove is arcuate in cross-section.

7. An anti-loosening threaded nut as defined in claim 1,2,3,4,5 or 6 wherein:
said outer end of said nut body defines a tool-receiving surface.

8. An anti-loosening nut as defined by claim 1 wherein:
said first and second seating faces are axially spaced from each other and,
including a cup-shaped washer having a peripheral rim with a load bearing surface in axial alignment with said first seating face, and
having and inwardly extending radial flange with a second load bearing surface thereon in axial alignment with said second seating face.

9. An anti-loosening nut as defined by claim 1 wherein:
said first and second seating faces are axially spaced from each other and,
including a flat washer and a belleville spring, said flat washer having a load bearing surface in axial alignment with said first and second seating faces, and
said belleville spring being disposed between said first seating face and said load bearing surface of said flat washer.

10. An anti-loosening threaded nut for use in a threaded fastener assembly which includes said nut in threaded engagement with a threaded shank which has a head thereon whereby a compressive force can be applied to a workpiece disposed between said nut and said head, said nut comprising:
a nut body defining a cylindrical threaded opening having a longitudinal axis and having an inner end and an outer end, said inner end being adapted for receiving said threaded shank and for confronting said workpiece,
said body defining first and second load seating faces on said inner end for transmitting compressive forces from said nut body to a workpiece, said seating faces extending transversely of said longitudinal axis, with said first seating face being disposed radially outwardly of said second seating face,
said first and second seating faces being in substantial transverse alignment and spaced radially from each other by an annular groove in said body,
whereby tightening of said nut on said threaded shank against said workpiece causes a load to be applied to the threads of said nut and said shank with a first part of said load being applied by said first seating face through a first load path to a first region of said threads and with a second part of said load being applied by said second seating face to a second region of said threads.

11. An anti-loosening threaded nut for use in a threaded fastener assembly which includes said nut in threaded engagement with a threaded shank which has a head thereon whereby a compressive force can be applied to a workpiece disposed between said nut and said head, said nut comprising:
a first nut member and a second nut member,
said first nut member having an inner end and an outer end and defining a threaded bore, said inner end having an extension sleeve for receiving said threaded shank in said threaded bore and said outer end comprising a tool receiving head with a radially extending flange surmounting said extension sleeve,
said first nut member defining first and second load seating faces for transmitting compressive forces from first nut member, said first seating face being disposed on said flange, said second seating face being disposed on the inner end of said extension sleeve,
a second nut member comprising a cup-shaped washer having a longitudinal axis in alignment with said longitudinal axis of said threaded bore, said extension member being rotatably received in said cup-shaped washer,
said cup-shaped washer having a rim with a first load bearing surface in axial alignment with said first seating face, and
having an inwardly extending radial flange with a second load bearing surface thereon in axial alignment with said second seating face,
whereby tightening of said nut on said threaded shank against said workpiece causes a load to be applied to the threads of said nut and said shank with a first part of said load being applied by said first seating face through a first load path to a first region of said threads and with a second part of said load being applied by said second seating face to a second region of said threads.
